(19) United States
(12) Patent Application Publication
(10) Pub. No.: US 2012/0310760 A1
(43) Pub. Date: Dec. 6, 2012

(54) MOBILE DEVICE AUTOMATIC CARD ACCOUNT SELECTION FOR A TRANSACTION

(76) Inventors: Simon Phillips, York (GB); Ronald D. Carter, Barrington (GB)

(21) Appl. No.: 13/223,590

(22) Filed: Sep. 1, 2011

Related U.S. Application Data
(60) Provisional application No. 61/493,195, filed on Jun. 3, 2011.

(51) Int. Cl. G06Q 30/00; G06Q 40/00

(52) U.S. Cl. 705/26.1; 705/42

(57) ABSTRACT

Methods, apparatus and systems are described for the automatic selection of a payment card account for use in a purchase transaction by a payment-enabled mobile device. In some embodiments, a user configures her mobile device so that it will automatically select a particular payment card account when certain predefined criteria are met. In an implementation, the process includes providing, by a processor on a display component of the mobile device, a payment card account menu that includes a representation of each of a plurality of payment card accounts of the user. After the mobile device receives an indication of a selection, a card account use criteria sub-menu is displayed that includes a plurality of criteria that defines circumstances under which that particular payment card account will be automatically selected for a transaction. The mobile device processor then receives criteria data selected by the user and stores the selected criteria data in association with an identifier of the particular payment card account in the mobile device memory. In some embodiments, the mobile device processor automatically selects the particular payment card account for use in a payment transaction based at least in part on the stored criteria data.

### CROSS-REFERENCE TO RELATED APPLICATIONS

This application claims the benefit of U.S. Provisional Patent Application No. 61/493,195 filed on Jun. 3, 2011, the contents of which are hereby incorporated by reference for all purposes.

### BACKGROUND

Payment cards such as credit or debit cards are ubiquitous. For decades, such cards have included a magnetic stripe on which the relevant account number is stored. To consummate a purchase transaction with such a card, the card is swiped through a magnetic stripe reader that is part of a point of sale (POS) terminal. The reader reads the account number from the magnetic stripe. The account number is then used to route a transaction authorization request that is initiated by the POS terminal.

In pursuit of still greater convenience and more rapid transactions at POS terminals, payment cards have recently been developed that allow the account number to be automatically read from the card by radio frequency communication between the payment card and a so-called “proximity reader”, which device may be incorporated with the POS terminal. Such cards are often referred to as “proximity payment cards” or “contactless payment cards”, and typically include a radio frequency identification (RFID) integrated circuit (IC), often referred to as a “chip” embedded in the card body. A suitable antenna is also embedded in the card body and is connected to the RFID chip to allow the chip to receive and to transmit data by RF communication via the antenna. In typical arrangements, the RFID chip is powered from an interrogation signal that is transmitted by the proximity reader and received by the card antenna. MasterCard International Incorporated, the assignee hereof, has established a widely-used standard, known as “PayPass®”, for interoperability of contactless payment cards and proximity readers. It has also been proposed to use wireless exchanges of information via NFC (Near Field Communication) for payment applications.

It has been proposed that the capabilities of a contactless payment card be incorporated into portable or mobile devices, thereby turning such mobile devices into contactless payment devices. Such a contactless payment device typically includes integrated circuitry with the same functionality as the RFID IC of a contactless payment card. In addition, the mobile device and/or contactless payment device includes a loop antenna that is coupled to the payment-related IC for use in sending and/or receiving messages in connection with a transaction that involves contactless payment.

This disclosure presents apparatus and methods including a user interface to facilitate and enhance the use of mobile telephones and/or other portable devices that have payment-related IC's that can be used for contactless payment transactions and other types of transactions. In particular, novel features and ways of interacting with a contactless payment-enabled mobile telephone are described. Accordingly, a user interface may be provided to enable a mobile telephone user to choose a payment card account, for example, and then to designate conditions and/or criteria to associate with that particular payment card account. In this example, the conditions and/or criteria define when that payment card account is to be automatically selected by the mobile telephone for use in a purchase transaction. Such operation enhances the speed and convenience of transactions that involve the use of contactless payment-enabled mobile telephones or other payment-enabled portable devices.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments (not necessarily drawn to scale), wherein:

FIG. 1 is a plan view of a contactless-enabled mobile telephone, in a flipped-open position, of a type that can contain features and processes in accordance with the present invention.

FIG. 2 is a block diagram representation of the mobile telephone of FIG. 1.

FIG. 3 is a block diagram showing details of a proximity payment control circuit that may be included in the mobile telephone of FIG. 2.

FIG. 4 is a diagram illustrating certain aspects of software that may be stored in the mobile telephone of FIGS. 1 to 3.

FIG. 5 is a flow chart that illustrates a process that may be performed in the mobile phone of FIGS. 1 to 3 in accordance with aspects of the present invention.

FIGS. 6-9 show screen displays that may be displayed, in accordance with aspects of the present invention, on a display component of the mobile phone of FIGS. 1 and 2.

FIG. 10 is a flow chart that illustrates a process that a user may perform using the mobile phone of FIGS. 1 to 3 in accordance with aspects of the present invention.

FIG. 11 is an enlarged screen display component illustrating the display of a large card-face image in accordance with aspects of the invention.

FIG. 12 is a flow chart illustrating another implementation of a process for purchasing goods or services using a mobile device in accordance with aspects of the present invention.

FIG. 13 is a flow chart illustrating yet another implementation of a process for purchasing goods or services using a mobile device in accordance with aspects of the present invention.

### DETAILED DESCRIPTION

In general, and for the purpose of introducing concepts of novel embodiments described herein, a user interface is provided in a mobile telephone that includes a wallet icon in a main menu. When the wallet icon is selected from the main menu displayed on the mobile phone display component, the main menu is replaced with a virtual wallet sub-menu that provides the user with several choices, including an automatic card selection option. If the user selects this option, then a card selection sub-menu appears that depicts card account choices (each card account may be represented by a card image or an icon that resembles the front face of, for example, a corresponding credit or debit payment card including information that typically appears thereon). The mobile telephone user then selects one of the card images, and is next presented with a card use criteria sub-menu. This sub-menu includes a title field identifying the card account that was chosen for configuring by the user, and the selections presented by the card use criteria sub-menu can be utilized by the mobile telephone user to define criteria such as the conditions or circumstances or situations under which that particular card account will be automatically selected for use in a transaction. For example, the mobile telephone user may select a debit card account and associate particular merchant criteria that, when met, causes that debit card account to be automatically selected by an application program of the mobile telephone for a transaction in the merchants' store. Accordingly, in some embodiments, the user interface permits a mobile telephone user to designate his or her preferences which define when a particular card account is to be automatically selected by the mobile telephone for use in a transaction. Such operation serves to enhance the speed and convenience of making purchase transactions. Thus, the apparatus and processes described herein facilitate and enhance the use of payment-enabled mobile telephones and/or other payment-enabled portable devices for use in contactless payment transactions and other types of transactions.

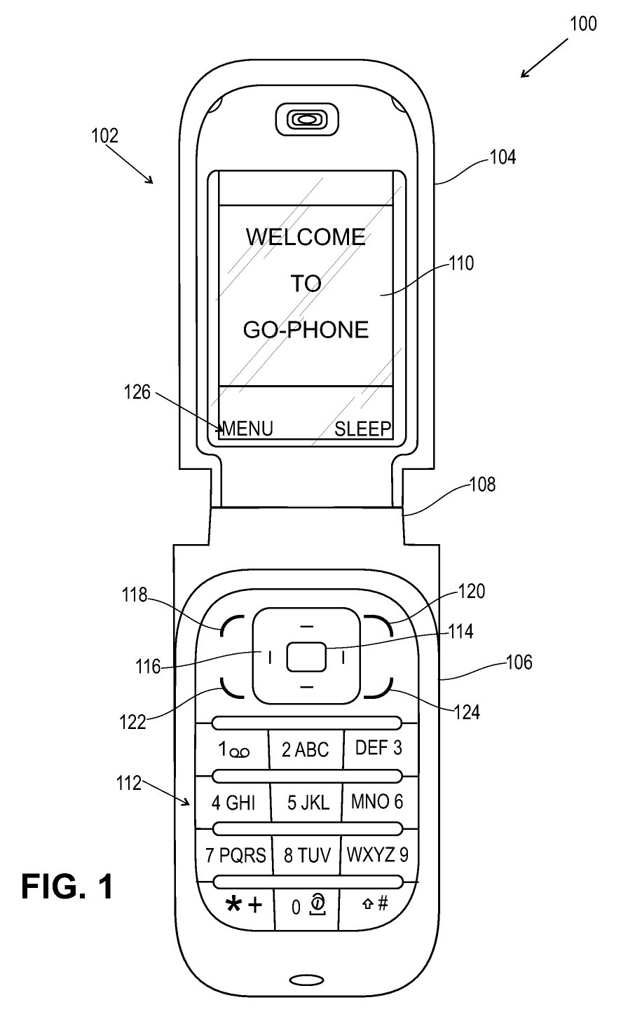

FIG. 1 is a plan view of a mobile phone 100 (in a flipped open condition) in which the present invention may be applied. The mobile phone 100 includes a conventional hinged housing 102, including a display housing portion 104 and a control housing portion 106. The display housing portion 104 and the control housing portion 106 are hingedly joined together at a hinge 108, and thus can pivot away from each other about the hinge to an open position (as shown), and pivot towards each other to a closed position (not shown). A conventional display component 110 is shown mounted in the display housing portion 104, and in some embodiments the display component 110 may be a touch screen. Various control buttons and switches are mounted on the control housing portion 106. These buttons and switches include a conventional telephone numeric keypad 112, and can also include a “select” button 114 nested within a four-way rocker/scroll switch 116. In the embodiment shown, further buttons and switches include soft-keys 118 and 120, a start call key 122 and an end call key 124.

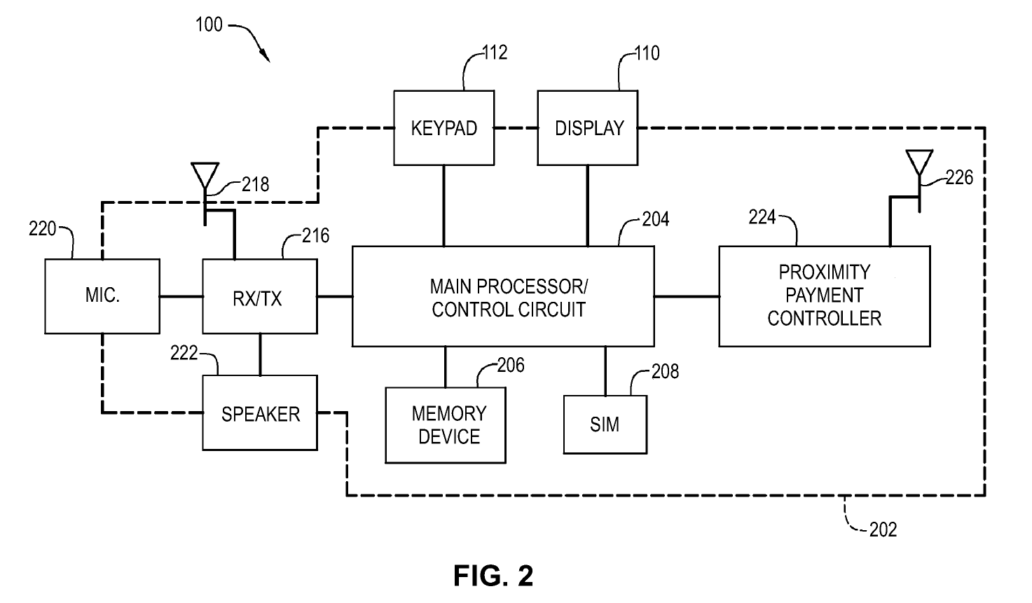

FIG. 2 is a block diagram representation of the mobile phone 100. Since the mobile phone 100 is also operable for contactless payment transactions, in addition to conventional mobile phone functions, it will sometimes be referred to herein as a mobile telephone/contactless payment device. It should also be understood that the novel processes described herein could also be applied to other contactless-enabled portable devices, such as personal digital assistants (PDAs), portable music players (such as an iPod™), and tablet computers.

Referring again to FIG. 2, the mobile telephone/contactless payment device 100 may include a conventional housing (indicated by dashed line 202) that contains and/or supports the other components of the mobile telephone/contactless payment device 100. The housing 202 may be shaped and sized to be held in a user's hand, and may for example fit in the palm of the user's hand. Conventional control circuitry 204 can be used to control the over-all operation of the mobile telephone/contactless payment device 100. The control circuitry may be, for example, a main processor or microprocessor manufactured by the Intel® Corporation that is configured for cell phone operation. Other components of the mobile telephone/contactless payment device 100, which are in communication with and/or controlled by the control circuitry 204, include: (a) one or more memory devices 206 (e.g., program and working memory, etc.); (b) a conventional Subscriber Identification Module (SIM) card 208; (c) the above-mentioned keypad 112 (which for present purposes will be understood to include the other buttons, switches and keys referred to above) for receiving user input; and (d) the above-mentioned display component 110 for displaying output information to the user. As mentioned earlier, in some embodiments the display component 110 is a touch screen capable of accepting user input as well as displaying information to the user, in which case the keypad 112 (including some or all of the buttons, switches and keys) may be omitted.

The mobile telephone/contactless payment device 100 also includes conventional receive/transmit circuitry 216 that is in communication with and/or controlled by the control circuitry 204. The receive/transmit circuitry 216 is coupled to an antenna 218 and provides the communication channel(s) by which the mobile telephone/contactless payment device 100 communicates via a mobile network (not shown). The mobile telephone/contactless payment device 100 further includes a conventional microphone 220, coupled to the receive/transmit circuitry 216, wherein the microphone 220 is for receiving voice input from the user. In addition, a loudspeaker 222 is included to provide sound output to the user, and is coupled to the receive/transmit circuitry 216.

The receive/transmit circuitry 216 may operate in conventional fashion to transmit, via the antenna 218, voice signals generated by the microphone 220, and to reproduce, via the loudspeaker 222, voice signals that are received via the antenna 218. The receive/transmit circuitry 216 may also handle the transmission and the reception of text messages and/or other data communications via the antenna 218.

The mobile telephone/contactless payment device 100 also includes a proximity payment controller 224 in the form of an integrated circuit (IC) or chipset of the kind embedded in contactless payment devices, such as contactless proximity cards, sometimes also referred to as “smart cards” or “chip cards.” The IC or chipset 224 may also be referred to as a “payment circuit”. The payment circuit 224 may be configured to store one or more card account number(s) that identify the card account(s) that has been issued to the individual who owns the mobile telephone/contactless payment device 100. In addition, the mobile telephone/contactless payment device 100 may include a loop antenna 226, coupled to the payment circuit 224. The payment circuit 224 may be configured to interact with an RFID proximity reader (or a NFC proximity reader) that may be associated with a POS terminal to provide a card account number (stored in the payment circuit 224) for a purchase transaction at the POS terminal. For example, the payment circuit 224 may be designed and/or programmed to operate in accordance with the above-mentioned PayPass® standard.

In some embodiments, the proximity payment circuit 224 may be at least partially integrated with the main processor control circuit 204. One or more payment application program(s) may be configured to run in the payment circuit 224 and/or the control circuit 204, and can be stored in the mobile phone 100. Functionality as described herein may be provided from program instructions stored in the proximity payment circuit 224 and/or in the memory device 206. The stored program instructions may control a processing element which may be the control circuit 204 or which may constitute at least part of the payment circuit 224. In accordance with conventional teachings, the mobile phone 100 may include a “secure element” (not separately shown) which may constitute a portion of the payment circuit 224/control circuit 204 or of the SIM card 208. The secure element may store the payment application program and card account number(s) and/or other sensitive information related to the payment capabilities and/or other transaction capabilities of the mobile phone/proximity payment device 100.

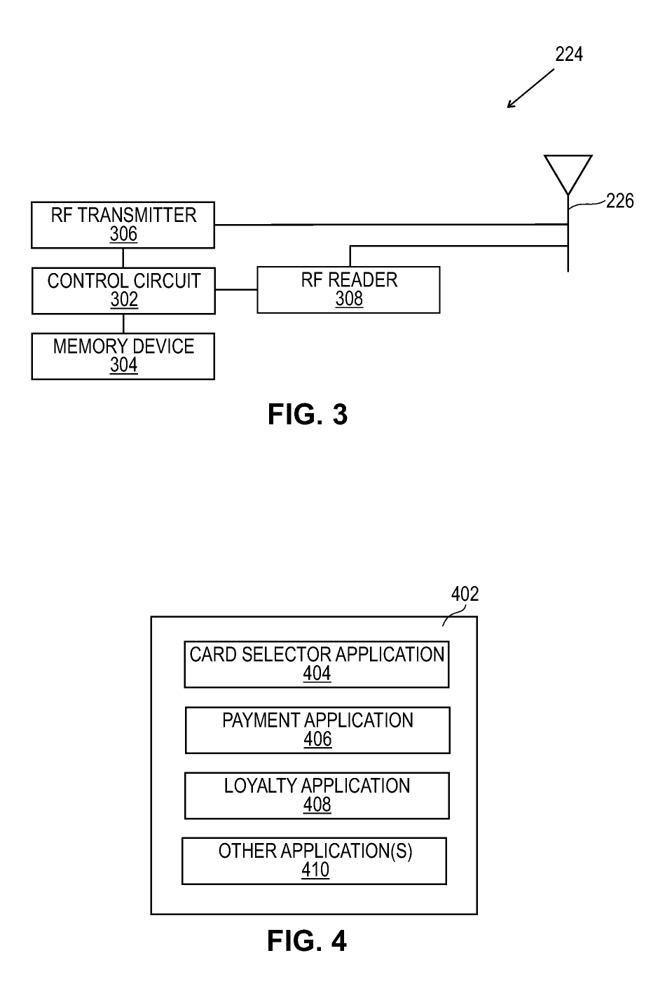

FIG. 3 is a block diagram illustrating details of an embodiment of a proximity payment circuit 224 suitable for use in a mobile device such as the mobile telephone 100. In particular, the payment circuit 224 includes a control circuit 302 which may be a microprocessor or microcontroller (or a circuit with similar functionality). As mentioned above, although shown as separate from the main processor 204 (FIG. 2) of the mobile telephone, the control circuit 302 may be integrated with the main processor. In either case, the control circuit 302 is configured for communication with the main processor 204 (as shown in FIG. 2).

Referring again to FIG. 3, the proximity payment circuit 224 further includes a memory device 304 in communication with the control circuit 302. The memory device 304 may be constituted by one or more different devices, and may overlap at least partially with the memory device 206 shown in FIG. 2. (Alternatively, the memory 304 may be separate from the memory 206 shown in FIG. 2.) The memory 304 may store one or more applications constituting program instructions that control the operation of the control circuit 302 (and/or main processor 204) and that cause the mobile telephone 100 to operate as a proximity device in the manner described herein.

The payment circuit 224 may also include an RF transmitter 306 coupled to the antenna 226 and to the control circuit 302. The RF transmitter 306 may be under the control of the control circuit 302 and may operate in a conventional manner. That is, the RF transmitter 306 may respond to interrogation signals (received from external RF readers that are not shown) by transmitting a payment card account number or other identifying operation. The RF transmitter 306 may operate in accordance with one or more conventional Radio Frequency Identification (RFID) standards, such as either of the above-mentioned PayPass® and NFC standards. In addition, and in accordance with aspects described herein, the payment circuit 224 may include an RF reader 308 that is coupled to the antenna 226 and to the control circuit 302. The RF reader 308 may be under the control of the control circuit 302 and may operate in accordance with conventional principles. For example, the RF reader may transmit an interrogation signal at regular intervals via the antenna 226 and after each interrogation signal may listen for a possible response signal/message from a nearby RFID tag (not shown in FIG. 3). For example, the RF reader transmits an interrogation signal while in a retail store such as “Best Buy” and listens for a response signal from an RFID tag that may be located near the cash registers. The RFID tag may transmit a signal that includes data identifying the merchant store as a “Best Buy” retail store, which enables the mobile telephone 100 to recognize the store. The RF reader 308 may also operate in accordance with a conventional standard for short distance RF communication, such as the NFC standard.

It should be understood that, in its hardware aspects, the mobile phone 100 may be entirely conventional, but it may be programmed, in accordance with aspects described herein, to provide a novel user interface and other novel functionality.

FIG. 4 illustrates in block form certain aspects of software (which may include one or more application programs) that may be stored in the memory 304 (see FIG. 3) and provided to control the payment circuit 224 of the mobile telephone 100. In particular, the blocks shown in FIG. 4 represent constituent elements of an electronic wallet function 402 that may be implemented in the mobile telephone 100. Thus, block 404 represents a card account selector application program 404 that permits a mobile telephone user to choose a card account and to select criteria and/or conditions for that card account that define when to automatically select that card account for a transaction. In some embodiments, the mobile telephone user can select a particular card account from a plurality of card accounts and choose one or more conditions that must occur for that card account to be automatically selected for a particular transaction. Block 406 represents a payment application program that allows the user to store and manage payment card account information in the mobile telephone 100, and that enables the mobile telephone to function as a contactless transaction device, for example, to enable the mobile phone user to purchase items from a merchant. Therefore, in some embodiments, the payment application program 406 is configured to store a plurality of user payment card account numbers and associated information, and to provide the functionality required for the mobile telephone to transform into a contactless transaction device. Block 408 is a loyalty application program that allows the user to store and manage customer loyalty and/or rewards card accounts that include identification credentials (e.g., identification and/or loyalty account numbers) associated with retailers and/or service providers. Thus, the loyalty application program may allow the mobile telephone 100 to also function as a contactless identification token by, for example, transmitting the loyalty program identification numbers to proximity readers present in retail stores. Block 410 represents certain other types of software applications that may be stored in the memory 304 (FIG. 3) that control and/or provide functionality associated with the payment circuit 224. For example, in some embodiments a transit access application program may be provided that allows the mobile telephone 100 to store the user's mass transit account number(s) so that the user's mobile telephone can function as a contactless access card for providing payment and/or access to a mass transit system (for example, permitting the user to ride on a city bus and/or to obtain a ride on a subway train).

It should be understood that an electronic wallet function may, in some embodiments, lack one or more of the application programs shown in FIG. 4. Also, in accordance with some embodiments, the electronic wallet function may include additional functions that are not illustrated in FIG. 4.

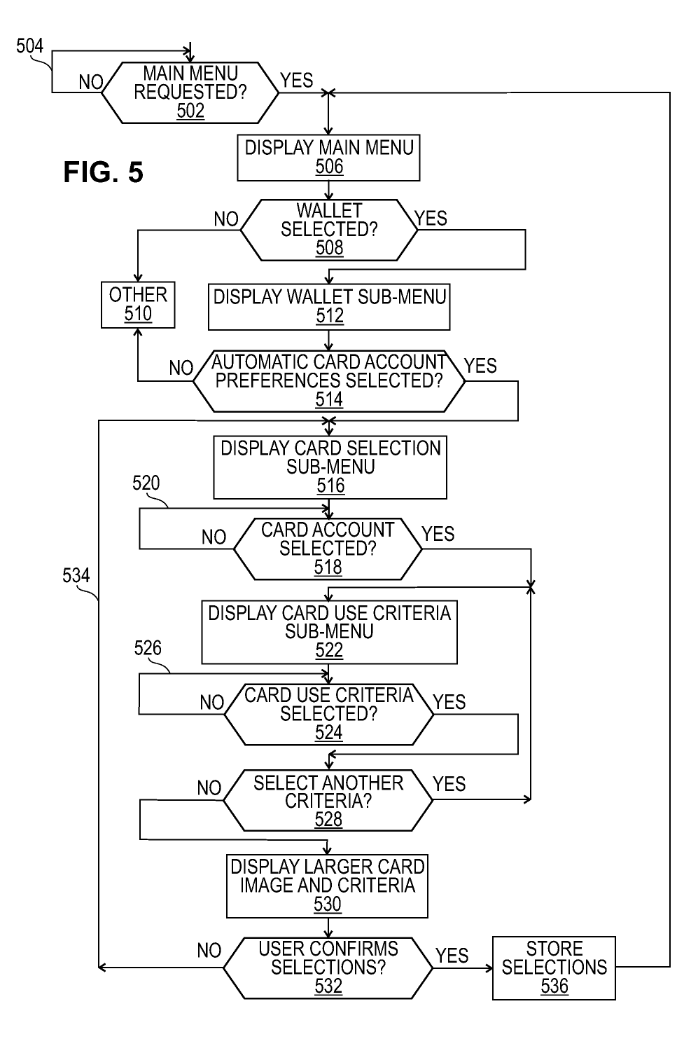

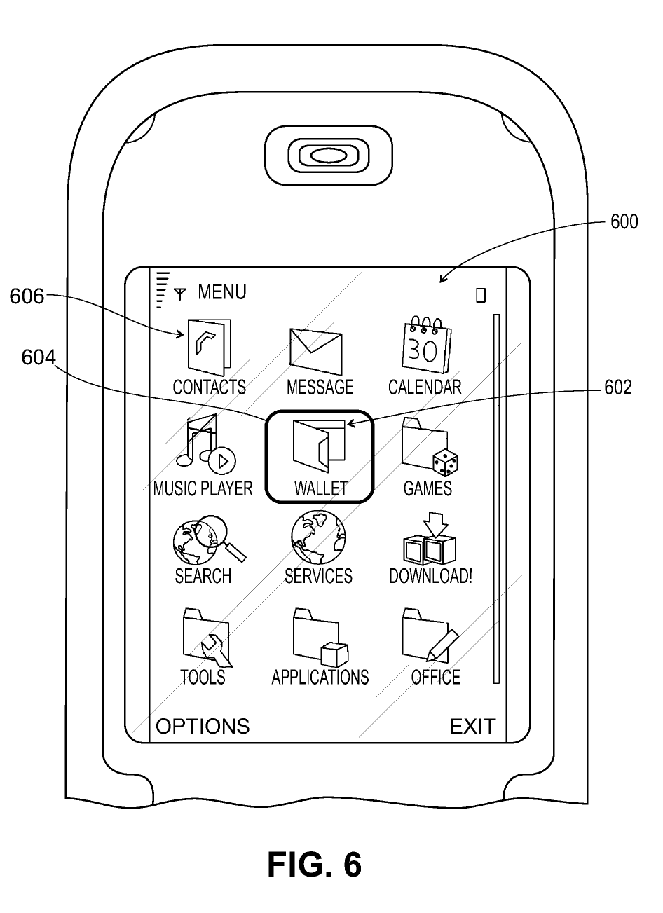

FIG. 5 is a flow chart 500 illustrating a process that may be performed in the mobile telephone/contactless payment device 100 in accordance with novel aspects disclosed herein. In particular, the process 500 is from the perspective of a mobile telephone user who wishes to set-up automatic card account selection functionality in her mobile device, such as her mobile telephone. FIGS. 6-9 show screen displays that may be presented, in accordance with described novel aspects, on the display component 110 of the mobile phone 100. In particular, FIGS. 6-9 illustrate aspects of the novel user interface mentioned above.

Referring to FIG. 5, the process 500 begins with the mobile phone 100 determining 502 whether the user has requested access to the main menu of the user interface. The user may select the main menu, for example, from a “welcome screen” that appears when the mobile telephone is powered on. An example of a welcome screen message is shown in FIG. 1 (“Welcome To Go-Phone”) on the display component 110 of the mobile telephone 100. A “Menu” icon 126 is depicted in the lower left-hand corner, which can be selected by the user by actuating the left-hand soft key 118. In some embodiments the mobile telephone 100 includes a touch screen instead of the display component 110, and in such case the user can use his or her finger to press on the “Menu” icon to request display of the main menu.

Until the user requests the main menu, the process of FIG. 5 may idle at decision block 502, as indicated by branch 504 from decision block 502. But once the user selects the main menu, the process advances to block 506 wherein the mobile phone displays the main menu, an example of which is shown in FIG. 6. In particular, FIG. 6 is an enlarged view of the display housing portion 104 of FIG. 1 with an example main menu display 600 replacing the welcome screen. As shown, the main menu 600 is displayed in a fairly conventional format with menu item icons including a “wallet” icon 602. The user navigates among the menu icons, for example, by operating the rocker switch 116 in the mobile phone handset (see FIG. 1). When the user navigates to a particular menu item, that menu item is highlighted as shown by the highlight indication border 604. The highlight indication border provides a visual indication to the user that the icon in question may currently be selected by actuating (pressing) the select button 114 (FIG. 1) with her finger. Accordingly, the menu display 600 as shown in FIG. 6 informs the user that actuation of the select button 114 will result in selection of the highlighted wallet icon 602. (The highlight indication border around a particular menu item may, for example, be referred to as a cursor.)

Referring again to FIG. 5, a decision block 508 may follow block 506 wherein the mobile phone 100 determines whether the user selected the wallet icon. If not, block 510 indicates that the process may idle, or that some other function has been selected by the user, which may be represented by selection of a menu item/icon different from that of the wallet icon 602. For example, referring again to FIG. 6, the user may have moved the cursor to the “Contacts” icon 606 and then pushed the “select” button 114 on the handset in order to choose that function to add and/or delete contact information. Referring again to decision block 508, if the user selects the wallet icon by moving the cursor 604 to the wallet icon 602 and pressing the select button 114, then the process advances to display 512 a wallet sub-menu. Thus, selection of the wallet icon provides the path by which the mobile telephone user may access operations related to performing contactless payment device functions. More specifically, selection of the wallet icon allows the user to access “virtual wallet” applications encompassing contactless payment options and payment card account data management functions.

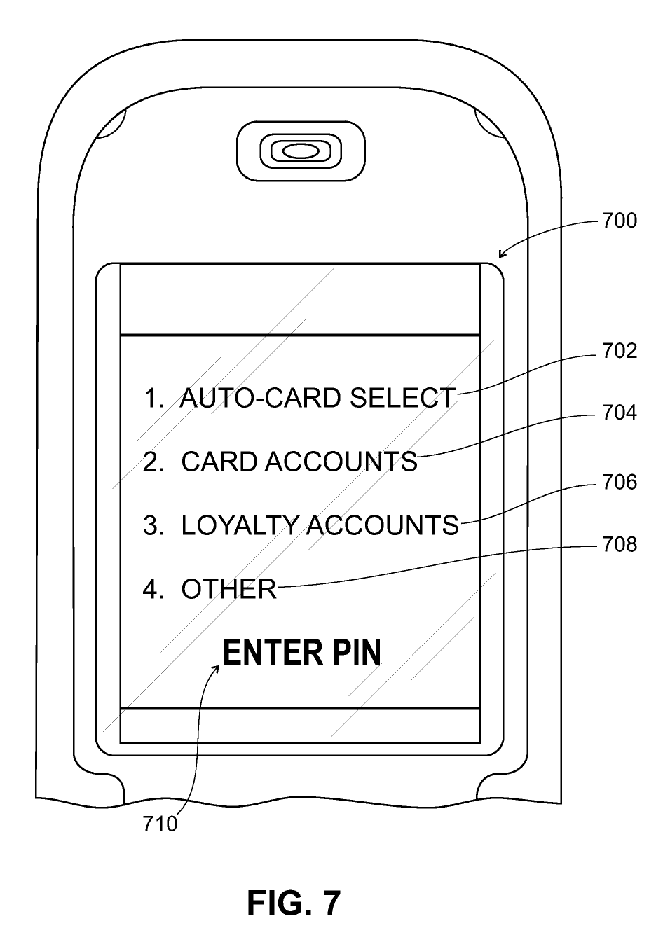

FIG. 7 is another enlarged view of the display housing portion 104 of FIG. 1, wherein a wallet sub-menu 700 is shown, which replaces the main menu display 600 shown in FIG. 6. The wallet sub-menu 700 is displayed in a fairly conventional format as a text list of items, but one skilled in the art will understand that other types of displays, for example one that includes icons, or a combination of text and icons, could be used as well. As shown, the wallet menu 700 displays options 702 to 708, and includes a prompt 710 that instructs the user to enter his/her personal identification number (PIN). The user may navigate the wallet sub-menu 700 by operating the rocker switch 116 on the mobile telephone control housing portion 106, and in some embodiments would first be required to her PIN before being permitted to select any of the options 702 to 708 which correspond to functions associated with her card accounts. Such a requirement (to first enter a PIN before being permitted to proceed to next steps) adds a layer of security to the process.

Referring again to FIG. 5, if at block 514 the user selects any of the options 2, 3 or 4 (reference numbers 704, 706 or 708 in FIG. 7), then the process branches to block 510, which means that a function has been selected other than the “auto-card select” 702 function. For example, if in FIG. 7 the user selected option 2 (reference number 704) from the sub-menu 700, which is “card accounts”, then a plurality of credit/debit card images may be displayed on the screen, wherein each such image represents the face or front side of a respective payment card issued to the user of the mobile phone. Each of such card-face images can show, among other information, the payment card account number for the card in question. (Those skilled in the art will recognize that payment card account numbers are a type of identification number. It will also be understood that card-face images for other types of cards may be displayed in addition to or instead of the payment card face images, and that identification numbers other than payment card account numbers may be included in such card-face images for other types of cards.) In addition to including payment card account numbers, the card-face images may provide other information customarily included on the face of a payment card such as the name of the cardholder (e.g., an individual cardholder's name and/or the name of a company or other organization in the case of a “fleet” card). Other elements of the card-face image may include the name and/or logo of the payment card association which authorized the issuance of the card, the name and/or logo of the issuer (that is, the issuing financial institution), certain color combinations related to the issuer and/or to the cardholder, and the expiration date of the card.

Referring again to FIG. 7, if the user chooses option 2, he or she can select one of the payment cards, for example, to use in a current transaction. The user could have also selected “Loyalty Accounts” 706 (option 3) or “Other” (option 4) from the wallet sub-menu 700 to access other functions.

Again referring to FIG. 5, if at block 514 the user selects the first wallet menu option, which corresponds to choosing the “automatic card preferences” option 702 (FIG. 7), in some embodiments the user is required to enter his or her PIN (for security purposes). Once the user PIN is entered, then the process 500 advances to block 516 wherein a card selection sub-menu of card account choices is displayed. The requirement for the user to enter a PIN guards against the possibility that the user of the mobile device is not the owner of a selected payment card account.

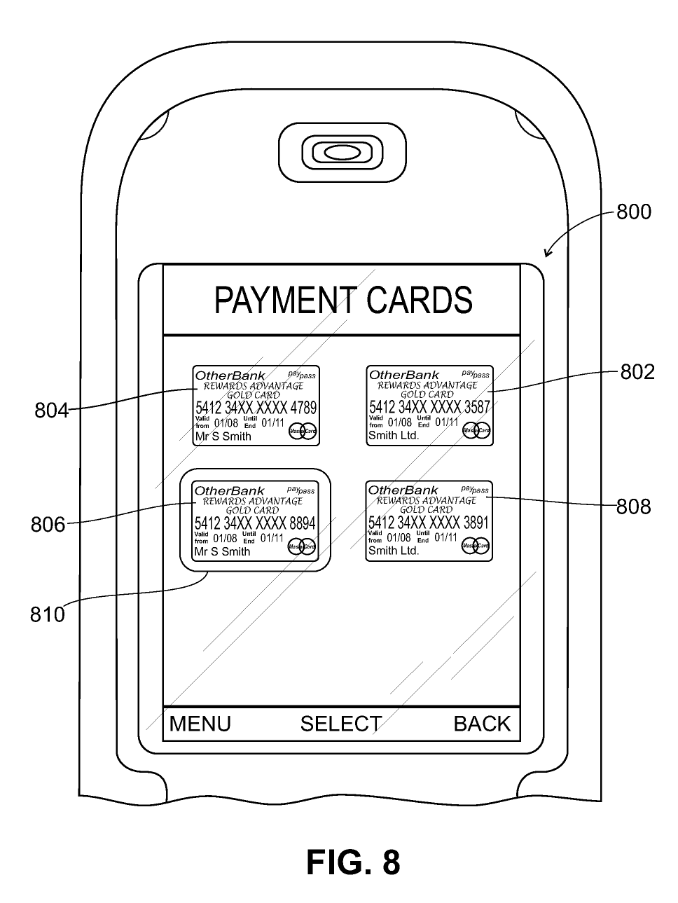

FIG. 8 depicts an embodiment of a “Payment Cards” sub-menu 800, and as shown includes a plurality of images 802, 804, 806 and 808. Each of the icons or images 802 to 808 represents the face or front side of a respective payment card account issued to the owner (the user) of the mobile phone 100. It should be understood, however, that the payment card accounts could be represented in alternate ways, for example, a simple list could be displayed that represents the payment card accounts stored in the memory of the user's mobile device. As mentioned above, the information shown on each of the card-face images 802 to 808 can include information such as the payment card account number, issuer bank name, issuer logo, card account holder name, the expiration date, a unique color or color combination, and/or other pertinent data. It should also be observed that the card-face images 802 to 808 do not overlap with each other. Rather, each of the card images is entirely surrounded by the background of the virtual wallet, payment cards sub-menu 800 display. In addition, as shown in FIG. 8, a cursor or highlight indication 810 is provided that indicates to the user that she has navigated to the card-face image 806. Consequently, if the user actuates the select button 114, doing so will effect selection of the card-face image 806, and thereby will also effect selection of the payment card account that corresponds to the payment card represented by the card-face image 806. Selection of that payment card account may result in the corresponding payment card account number being selected for defining one or more criteria or conditions, as determined by the user, so that when such criteria or conditions are met or satisfied then that payment card account can be automatically selected for use in a purchase transaction. In some embodiments, selection of a particular card-face image, such as card-face image 806, causes the sub-menu 800 to be replaced with an enlarged version of the card-face image 806. The enlarged card-face image is a visual cue to the user that he/she has selected that payment card account (which corresponds to the account number included in the image). In addition, in some embodiments, the enlarged card-face image includes information that either was not provided or was illegible in the smaller card-face image, which information may help the user determine whether or not to continue with the selection process. Also in some embodiments, the user may be required to enter a PIN or code before selecting a payment card.

Stepping back from the payment card account sub-menu 800 display of FIG. 8, it should be understood that at least some of the data required to represent or build the card-face images may have been downloaded to the mobile phone 100 from an issuer financial institution computer or service provider computer system in conjunction with the downloading of the corresponding payment card account numbers and related information. As is familiar to those skilled in the art, the process of loading account-specific or card-specific information into a mobile phone (or indeed into any payment card or proximity payment device) is commonly referred to as “personalization”. It is contemplated for present purposes that personalization may take place via any conventional mechanism or by any mechanism that is hereafter proposed. Examples of personalization mechanisms that may be used are over-the-air (OTA) personalization or personalization via short range RF communication with a personalization card, as disclosed in commonly-assigned U.S. patent application Ser. No. 11/870,144, filed on Oct. 10, 2007, which is hereby incorporated by reference herein.

To elaborate, in accordance with aspects described herein, conventional “personalization” transactions for mobile phones may be augmented with downloading of the image information to allow for display of a card-face image that corresponds to the payment card account number and other information downloaded to the mobile phone during personalization. The image information may be a bitmap, or may include background color indicators, logo indicators, and/or other data from which the mobile phone is able to construct a bitmap image for the card face in question. Techniques for representing the card image data in an efficient manner are disclosed in commonly-assigned U.S. patent application Ser. No. 12/170,550, filed on Jul. 10, 2008, which is incorporated herein by reference.

The personalization process may, in some embodiments, result in the payment card account number, the image information, and other data all being stored in a payment application program that is stored in the mobile telephone 100. It may be the case that a separate personalization process was performed for each card image/account number that is included in the payment card account sub-menu display. (The card image information loaded into the mobile phone during personalization may also include information required to display and/or construct an image of the rear face of the payment card in question, which information may be needed in some cases to consummate a purchase transaction.)

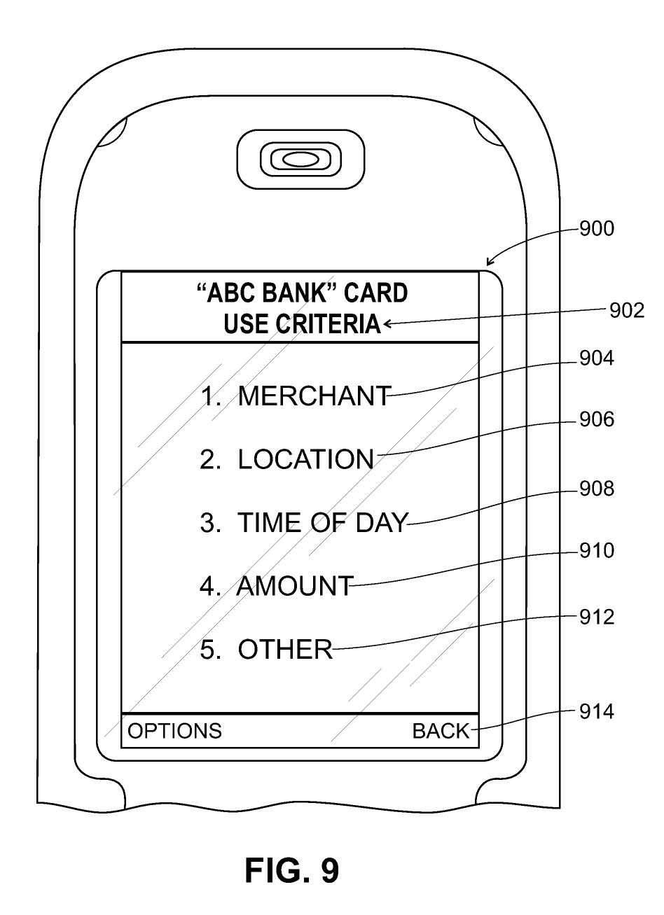

Referring again to FIG. 5, in decision block 518 the mobile phone 100 determines whether or not the user has selected one of the card images icons in the virtual wallet menu of FIG. 8. If a card has not been selected, then the process may idle for a predetermined amount of time, as indicated by branch 520. In some embodiments, if the predetermined amount of time expires, then the process may revert back to block 502 to display the main menu, or to display the “welcome screen”. But if the user selects the card icon 806 of FIG. 8, for example, by actuating the select button 114, then a card account use criteria sub-menu (900, see FIG. 9) is displayed 522 which replaces the payment card account sub-menu 800 of FIG. 8.

FIG. 9 illustrates an example of a card account use criteria sub-menu 900. The card selection criteria sub-menu is displayed in a fairly conventional format as a text list of items, but one skilled in the art will understand that other types of displays, such as icons, could be used as well. The card account use criteria sub-menu 900 includes a title field 902 that indicates the name of the card account selected by the mobile phone user. The title field thus serves as a visual indication to the user that he or she is about to define criteria that will be associated with that payment card account. If the mobile phone user realizes that she or he chose the wrong payment card account, then she can select the “Back” icon 914, for example, by pressing on the soft key 120 on the control housing portion 106 of the mobile telephone 100 (FIG. 1) to again display the payment card account sub-menu 800 of FIG. 8. However, if the correct payment card account was selected, then the user can utilize one or more of the five options 904-912 presented by the sub-menu 900 to define conditions and/or criteria for use of that payment card account.

The example sub-menu of FIG. 9 shows five options that can be selected by the mobile phone user: “Merchant” 904 (option 1), “Location” 906 (option 2), “Time of Day” 908 (option 3), “Amount” 910 (option 4), and “Other” (option 5). Selection of any of these options causes one or more additional sub-menus to appear, and then the user can select from various further criteria data that appear on such sub-menus. For example, if the mobile phone user selects option 4, which is the “Amount” option 910, then another sub-menu may appear (not shown) that prompts the mobile phone user to select an amount by using the number keys on her touch pad, or to select a range of amounts, that defines the expenses for which that payment card can be used. For example, five options may be presented: “Less than $20”, “Range of $21 to $100”, “Range of $101 to $199”, “Greater than $200”, and/or “Define Amount”. (If the “Define Amount” option is chosen, then yet another sub-menu (not shown) may appear that permits the mobile phone user to enter a customized range or amount by using the numerical keys on her device.) If the mobile phone user selects the “Less than $20” option, then criteria data is selected that defines a circumstance when that particular payment card account will be utilized whenever the mobile telephone is used as a payment device to purchase an item that costs less than $20. But the user can add other criteria data as well by making further selections, and that data can be aggregated for that particular payment card account so as to narrow or further define the circumstances under which that particular payment card account will be used, as will be explained below.

Referring again to FIG. 5, if it is determined in step 524 that the user has not made a selection, then the process may idle, as indicated by branch 526, for a predetermined time interval after which the main menu screen may again be displayed. But if it is determined in step 524 that the user selected a card use criteria, then the user is asked (step 528) whether she would like to select or designate additional criteria data to associate with the particular payment card account. For example, in some embodiments, a prompt may be displayed such as “Select Another Criteria?” with a “Yes” and a “No” icon available for selection by the user. In the case where the user answers “Yes” to the question “Select Another Criteria?” (step 528), then the process branches back to step 522 and the sub-menu 900 (FIG. 9) is again displayed so that the user can select further criteria. Continuing with the above selection criteria example, the user may next choose the “Merchant” option 904 and then be presented with the names and/or descriptions of various types of merchants, such as “Candy Store”, “Supermarket”, “Convenience Store”, “Deli”, and the like. If the user selects “Deli” then the chosen payment card account will automatically be selected whenever the user is utilizing the mobile telephone/contactless payment device 100 in a Deli for purchases of less than $20 (twenty dollars). Thus, in some embodiments the user can combine two or more criteria to define automatic account selection criteria that must be satisfied for the consumer's mobile device to automatically select a particular payment card account for a purchase transaction.

Referring again to FIG. 5, in step 528 when the user selects “No” in response to the “Select Another Criteria?” question, in some embodiments a list is displayed 530 of the users' criteria choice(s) along with an enlarged payment card image so that the user can visually check the criteria chosen for that payment card account. A prompt may also be displayed to the user in order for her to confirm the selection(s) that were made and that will be followed in the future to automatically select that payment card account for such purchase transactions. When the user confirms 532 the selections, for example by selecting a “Confirm” icon, then the selected criteria and/or conditions for that payment card account are saved or stored 536 in the memory of the mobile telephone, and the mobile telephone displays 506 the main menu. However, if in step 532 the user does not confirm her selections, for example by selecting a “Cancel” icon, then in some embodiments the process branches 534 back to step 516 wherein the card selection sub-menu 800 of FIG. 8 is again displayed.

Referring again to the card account use criteria sub-menu of FIG. 9, selection of the “Merchant” option 904 may permit the mobile telephone or contactless payment device user to select a particular payment card account for automatic selection when purchasing goods or services from one or more particular merchants. For example, the mobile telephone user can choose a bank-branded payment card account (for example, a “Sears™” store charge card account) and configure it so that it will be automatically chosen for a purchase transaction whenever the mobile telephone recognizes that items are to be purchased at a “Sears™” retail store. (The mobile telephone may “recognize” that it is in a “Sears™” retail store, for example, by way of GPS coordinates, or by receiving a wireless signal that identifies the location or store, or by receiving RFID data from a store reader device, and the like.) In some embodiments, the mobile telephone may be configured to automatically recognize that a particular card account is already linked to a loyalty program or rewards program at a particular merchant (such as a loyalty program of bookseller “Barnes & Noble™”) and thus automatically select that particular card account for activation whenever the user's mobile device is in that merchant's retail store. In another example, the mobile telephone may recognize that the consumer has pulled up to a gasoline station and therefore automatically selects a gas-branded payment card account for use to purchase fuel. In such cases, use of the automatically selected particular card account may be mandated by the issuer of that payment card account. Thus, if the mobile telephone user tries to choose a different card account for automatic selection with that particular merchant, in some embodiments the automatic card selection application program may cause the mobile device to display a message for the consumer stating that a particular card account has already been designated for transactions with that merchant. In such a case, if the consumer still wishes to select a different payment card account he or she may have to enter a PIN in order to select a different payment card account for automatic use with that particular merchant. Thus, in some embodiments, rules may exist in an application in the mobile device, for example, that allow only one particular payment card account to be automatically selected for use with a particular merchant.

Accordingly, the mobile device user could designate a card account for use with “brick and mortar” retailers such as “Whole Foods™”, “Best Buy™”, “Lord & Taylor™”, and/or “Macys™”, and/or the mobile device may be configured to automatically select a payment card account based on a merchant identifier or some other predefined criteria. In addition, the mobile device user may designate one particular payment card account for use when making on-line purchases, or the mobile device may be configured to automatically select a particular payment card account based on receipt of an on-line merchant identifier or the like, for example.

In yet another example, automatic card account selection criteria could correspond to the types of goods or services being purchased. For example, the mobile phone user can designate a particular card for use only when purchasing electronic devices (i.e., flat-panel displays, computers, stereo components, music players, digital cameras and the like), or office supplies, or software, or entertainment (i.e., theater tickets and or movie tickets), or food, or gasoline, or gardening supplies, or to pay utility bills, business expenses or travel expenses, and the like, or some predefined combination thereof. Accordingly, a particular payment card account could be designated for automatic selection by the mobile device whenever a payment transaction involving one or more of these types of goods or services occurs.

In addition, in some embodiments as mentioned above, criteria can be combined for any particular designated payment card account. For example, a mobile telephone user can designate payment card account “X” for use on weekdays between the hours of 8 am and 10 am for purchases of $30 dollars or less per day, and can designate payment card account “Y” for use on weekdays from 11 am to 2 pm for purchases up to $200 dollars. One skilled in the art would recognize that many other types of criteria data in many different combinations could be utilized.

In some embodiments, a particular combination of criteria can be selected and combined and then locked on a mobile device by a user (or by an entity) for a particular mobile device and/or for a particular designated payment card account. In some embodiments, locking the payment card account criteria or conditions may include using a password or PIN (which may be chosen by the user and/or entity that owns the mobile device). The password or PIN is then required in order to modify, delete, or otherwise change the conditions under which a particular payment card account is automatically selected by the processor of the mobile device for a purchase transaction.

For example, an organization or company may issue payment-enabled mobile telephones to employees for work purposes. A particular company payment card account named “Off-Supply” can be chosen by the entity for employee use to purchase office supplies from specified merchants. Other conditions can also be specified, such as the “Off-Supply” payment card account can only be used for purchase transactions on weekdays between the working hours of 9 am to 5 pm, and only for purchases of $50 dollars or less per day. Such an “Off-Supply” payment card account can be locked by the employer, such that the employee cannot change any of the criteria data (such as the conditions) that must be satisfied for the mobile device to automatically select the “Off-Supply” payment card account (because the employee does not have access to the required password (such as a company PIN), and/or does not have access to a website (that requires a password to login) where such criteria and/or settings can be changed). The company mobile telephone may also include features that prevent employees from overriding any of the payment card account conditions, and/or from adding or deleting any payment card account information. The same company or entity can designate a different and/or additional payment card account named “Clients” in the company mobile telephones for use by employees to entertain clients by, for example, taking them to lunch and/or to dinner. The “Clients” account may include limiting criteria data and/or conditions on usage such as for use only in restaurants during the time ranges of noon to 2 pm and 5 pm to 9 pm, and only up to a per day amount limit such as $100 per weekday, which may be locked as well. Thus, an employee mobile device may include a wallet function that automatically selects payment card accounts depending on employee payment transaction activities.

Another situation in which having a locking feature can be handy is the case where a parent selects payment card account criteria for a child's mobile device. In this example, the parent may enter criteria for one or more payment card accounts stored on the child's mobile telephone so that the child can only utilize the payment capability during certain hours in selected stores and only up to a maximum amount of money per day. Thus, criteria can be chosen that allows the child to utilize her mobile telephone to make purchases during weekdays in a school cafeteria, but that also prevents her from making a purchase in a liquor store, for example. Such criteria can be locked so that it can only be changed or modified by the parent (who is the only person who has access to the passwords and/or PINS required to make changes). The parent may occasionally wish to further constrain usage or to permit wider usage at particular times as the child ages (as the child hopefully becomes more responsible), and/or as family circumstances change, and the like.

It is also contemplated that a mobile device user could utilize a website, which may be a secure website operated by a bank issuer computer, for example, to manage her payment card accounts, to enable or disable a locking feature, and to select one or more of such card accounts for automatic selection by her mobile device. Such a website may be password protected and configured to accept mobile device user input concerning automatic selection criteria and/or conditions, and to download such criteria to the user's mobile device. In such an implementation, as mentioned above the user's mobile device includes application programs and/or software (or can download the same) capable of utilizing the data from the website to enable the mobile device to automatically select a card account of the user for a transaction whenever the predefined criteria and/or conditions are satisfied.

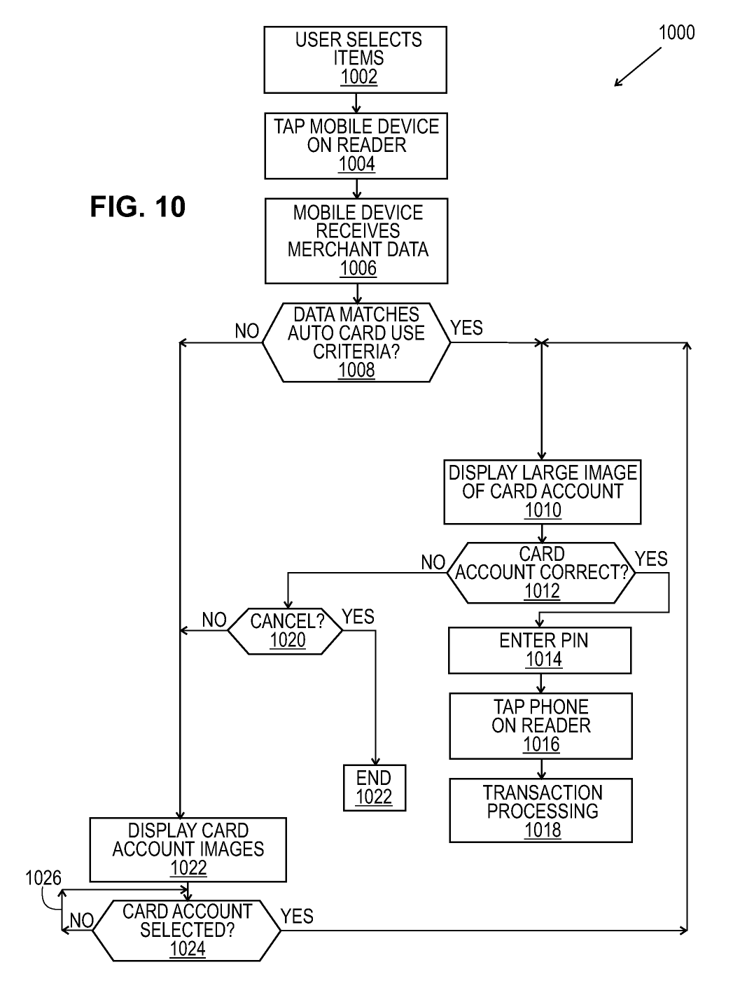

FIG. 10 is a flow chart illustrating an implementation of a process 1000 that a user may perform to purchase goods or services using the mobile phone/contactless payment device 100 in accordance with aspects described herein. In particular, the process 1000 is in the context of a visit by the mobile telephone user to a retail store, presented largely from the point of view of the user or consumer. The process assumes that the mobile telephone user has designated and/or configured at least one of her payment card accounts for automatic selection in accordance with the processes disclosed herein, so that when one or more of the predetermined user criteria or conditions is/are satisfied then a payment card account is automatically chosen for a purchase transaction.

Referring to FIG. 10, the shopper and mobile telephone user selects 1002 the items or merchandise that she wishes to purchase. In some embodiments, as she is shopping in the retail store, the user taps 1004 her mobile telephone on a merchant proximity reader component located in the retail store. The merchant proximity reader component may be marked for easy mobile device user recognition, and/or it may be embodied in any of a number of items such as a poster, a conveyer separator or another object. In a typical situation, the merchant will deploy one or more proximity readers near the retail store POS terminals (cash registers), or they may be deployed in any other convenient location about the retail store floor. When the shopper brings the mobile telephone 100 into proximity with the merchant proximity reader component, it is exposed to an interrogation signal transmitted from the merchant proximity reader component. The interrogation signal stimulates the mobile telephone 100 to exchange wireless RF communications with the merchant proximity reader component in accordance with conventional principles. Information can then be exchanged, including transmitting a merchant identifier from the merchant proximity reader component to the mobile telephone. The mobile telephone/contactless payment device 100 can then utilize the merchant identifier to attempt to automatically select a particular payment card account for use in a purchase transaction in that retail store. In some embodiments, the card selector application program 404 (FIG. 4) is initialized upon receipt of the merchant identifier to attempt to match that information to stored criteria information associated with a payment card account of the user. As described above, the stored criteria were chosen beforehand by the user for a chosen card account. Thus, such operation allows the mobile telephone to identify the merchant's store and to select the card account or payment product that the user has designated for payment transactions that involve that merchant.

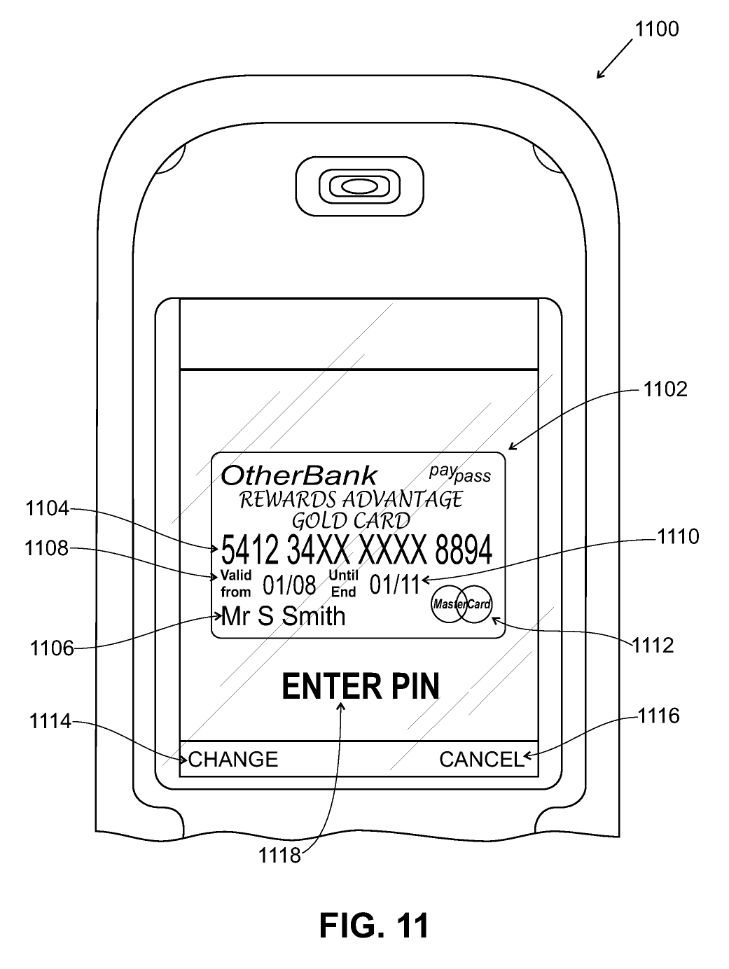

Referring to FIG. 10, if a match occurs in step 1008 (between the merchant identifier and criteria for a designated card account), then in some embodiments a large card account image (in the form of a payment card image, as explained above) is displayed 1010 on the mobile telephone screen for viewing by the user. For example, FIG. 11 is an enlarged view 1100 of the display portion 104 of the mobile telephone 100 of FIG. 1 that includes an embodiment of a large card-face image 1102 of the type that may be displayed. The large card-face image provides a visual cue to the user of the payment card account that has been automatically chosen for presentation to the merchant for a payment transaction. The large card-face image 1102 may include elements familiar to the user such as a credit or debit card sixteen-digit account number 1104, the cardholder's name 1106, a valid from date 1108, valid to date 1110, and card brand (i.e., association brand) logo 1112. In some embodiments, an “Enter PIN” prompt 1118 may be displayed below the large card account image. In addition, a “Change” command icon 1114 may be included on the lower left portion of the screen, and a “Cancel” command icon 1116 can be included on the lower left portion of the screen, to allow the user to actuate a soft key to opt for selection of another payment card account number (Change) or another mobile telephone function (Cancel). Although it may be advantageous to display a large card account image as shown in FIG. 11, it should be understood that the mobile telephone may present the same or similar information to the user in other ways, including, e.g., by displaying simple strings of characters that indicate the automatically-selected payment card account number and branding information for that payment card account.

The user acknowledges 1012 in FIG. 10 that the automatically selected card is correct by entering 1014 her personal identification number (PIN) by use of the numeric keypad 112 of the mobile phone 100. In some embodiments, the mobile phone may operate such that a payment transaction (or at least a transaction in an amount above a certain limit) is not enabled unless the PIN had been recently entered into the phone. The mobile phone user/shopper then taps 1016 her mobile telephone on the POS reader associated with the POS terminal (cash register) in the retail store to consummate the transaction. Consummating the transaction may include the mobile phone wirelessly transmitting the selected payment card account number to the proximity/contactless reader, and exchanging other data between the reader and the contactless payment application/circuitry of the mobile phone. In accordance with some conventional practices, the mobile phone may cryptographically generate a dynamic security code (CVC3) for the transaction and transmit the dynamic security code to the reader.

Thus, in some embodiments, the automatically-selected payment card account number is then transmitted by the mobile phone to the POS terminal in connection with the contactless payment purchase transaction, and conventional transaction processing 1018 occurs. In some embodiments, as part of the transaction processing, the merchant may require the mobile telephone user to provide her signature, which the user may do, for example, by using a pen to inscribe her signature on a transaction ticket, or by “signing” a tablet touch screen at the POS terminal with a stylus. Also in some embodiments, a card-back image (not shown) may replace the large card-face image 1102 during transaction processing 1018. The card-back image may include elements such as the user's signature, which may be derived from an image of the user's signature stored in the issuer's records, and may be combined with other elements, such as a stock frame image that is modified to reflect card specific information such as the CVC2 and/or an image of the card account owner. The merchant can then request to view the card-back image so as to compare the user's signature to that appearing on the mobile phone display screen (and/or to compare the image of the card account owner to the mobile phone user) to aid in authenticating the user's identity, and/or to view other information that may be included.

Referring again to FIG. 10, if in step 1012 the mobile phone user decides, after viewing the large image of the automatically-selected card account, that she does not wish to make a purchase, then she can select 1020 the “Cancel” command icon 1116 by actuating soft-key 120 (FIG. 1) and the process ends 1022. However, if in step 1012 the mobile phone user wishes to complete the payment transaction with another payment card account then instead of actuating the Cancel command 1116, she can then select the “Change” command icon 1114 by pressing the soft-key 118 (FIG. 1) to display 1022 the payment card images (FIG. 8) to make a different choice of card account. The process then proceeds to step 1024, wherein if a choice is made then that payment card account is displayed 1010 as a large image of the card account and the user proceeds as explained above to consummate the transaction. If, in step 1024 the user does not make a choice of another payment card account, then the process may idle as shown by branch 1026 for a predetermined amount of time after which the mobile telephone may, for example, exit to display the main menu screen. In addition, if in step 1008 there is no match found to the merchant identifier and any of the automatic card use criteria, then the process continues to step 1022 wherein the shopper is presented with card account images and can select a payment card account to utilize in the transaction, as explained above.

The process illustrated in FIG. 10 has elements that promote transaction security both for the mobile telephone user (cardholder) and for the merchant. For the mobile telephone user, the requirement that she enter her PIN to enable the transaction adds a second (knowledge) factor to the first (possession) factor inherent in a payment-enabled mobile telephone. For the merchant, the display of the user's stored signature via the mobile telephone display allows the merchant to authenticate the user's signature with substantially the same reliability as has conventionally been applied with cardholder signatures appearing on the back of conventional payment cards (such as credit and/or debit cards).

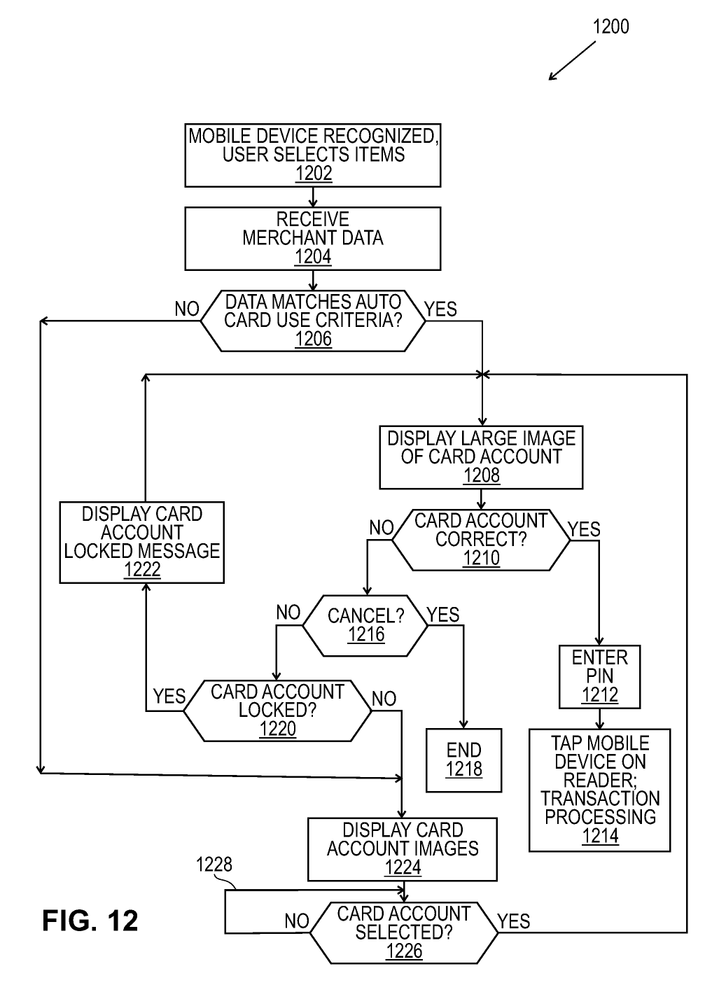

FIG. 12 is a flow chart illustrating another implementation of a process 1200 that a user may perform to purchase goods or services using the mobile phone/contactless payment device 100 in accordance with aspects described herein. The process 1200, like the process 1000 of FIG. 10, is in the context of a visit by the mobile telephone user to a retail store, presented largely from the point of view of the user or consumer. The process assumes that the mobile telephone user has designated and/or configured at least one of her payment card accounts for automatic selection in accordance with the processes disclosed herein, so that when one or more of the predetermined user criteria or conditions is/are satisfied then a payment card account is automatically chosen for a purchase transaction.

Referring to FIG. 12, the shopper (the mobile telephone user) enters the store (for example, a “Wal-Mart™” store) and her mobile device is recognized 1202 as she chooses the items or merchandise that she wishes to purchase. In some embodiments, the mobile telephone is “recognized” based on global positioning system (GPS) data which causes the mobile device to receive 1204 or to otherwise identify the merchant's store (for example, the GPS coordinates are matched to the location coordinates for the Wal-Mart™ store). In some other embodiments, in order for the mobile telephone to be recognized, the user taps her mobile telephone on a merchant proximity reader component located in the Wal-Mart™ retail store that is marked for easy mobile device user recognition. Such a merchant proximity reader component may be embodied in any of a number of items such as a strip in part of a poster, or as part of another object, and it could be positioned by the entrance or entryway to the store or other convenient location. When the shopper brings her mobile telephone 100 into proximity with the merchant proximity reader component, it is exposed to an interrogation signal transmitted from the merchant proximity reader component which stimulates the mobile telephone 100 to exchange wireless RF communications in accordance with conventional principles. Information can then be exchanged, including receiving a merchant identifier in the mobile telephone which can be used to attempt to automatically select a particular payment card account for use in a purchase transaction in that retail store. In some embodiments, the card selector application program 404 (FIG. 4) is initialized upon receipt of the merchant identifier to attempt to match that information to stored criteria information associated with a payment card account of the user. As described above, the stored criteria were chosen beforehand by the user for a chosen card account. Thus, such operation allows the mobile telephone to identify the merchant's store as, for example a Wal-Mart™ store, and to select the payment card account that the user designated for payment transactions involving items chosen for purchase at Wal-Mart™.

Referring to FIG. 12, if a match occurs in step 1206 (between the merchant identifier and criteria for a designated card account), then in some embodiments a large card account image (in the form of a payment card image) is displayed 1208 on the mobile telephone screen for viewing by the shopper. For example, the enlarged view 1100 shown in FIG. 11 of the display portion 104 of the mobile telephone 100 of FIG. 1 includes an embodiment of a large card-face image 1102 of the type that may be displayed. The large card-face image 1102 may include elements familiar to the user such as a credit or debit card sixteen-digit account number 1104, the cardholder's name 1106, a valid from date 1108, valid to date 1110, and card brand (i.e., association brand) logo 1112. In some embodiments, an “Enter PIN” prompt 1118 may be displayed below the large card account image. In addition, a “Change” command icon 1114 may be included on the lower left portion of the screen, and a “Cancel” command icon 1116 can be included on the lower left portion of the screen, to allow the user to actuate a soft key to opt for selection of another payment card account number (Change) or another mobile telephone function (Cancel). It should be understood that the mobile telephone may present the same or similar information to the user in other ways, such as by displaying simple strings of characters that indicate the automatically-selected payment card account number and branding information for that payment card account.

In some embodiments, the shopper acknowledges 1210 in FIG. 12 that the automatically selected card is correct by entering 1212 her personal identification number (PIN), for example by using the numeric keypad 112 of her mobile phone 100. The mobile phone may operate, in some cases, such that a payment transaction (or at least a transaction in an amount above a certain limit) is not enabled unless the PIN had been recently entered into the phone. The mobile phone user/shopper then taps 1214 her mobile telephone on a proximity reader associated with the POS terminal (cash register) in the retail store to consummate the transaction. In some embodiments, consummating the transaction may include the mobile phone wirelessly transmitting the selected payment card account number to the proximity/contactless reader, and exchanging other data between the reader and the contactless payment application/circuitry of the mobile phone. In accordance with some conventional practices, the mobile phone may cryptographically generate a dynamic security code (CVC3) for the transaction and transmit the dynamic security code to the reader. In yet some other embodiments, the shopper may not be required to tap her mobile telephone on a proximity reader. Instead, the mobile telephone may be configured to wirelessly transmit all necessary data to a merchant device receiver (which may be associated with a POS device) to initiate transaction processing.

In some embodiments, as part of the transaction processing 1214, the merchant may require the mobile telephone user to provide her signature, which the user may do, for example, by using a pen to inscribe her signature on a transaction ticket, or by “signing” a tablet touch screen at the POS terminal with a stylus. Also in some embodiments, a card-back image (not shown) may replace the large card-face image 1102 of FIG. 11 during transaction processing 1018 so that the merchant can view certain user elements such as the user's signature, which may be derived from an image of the user's signature stored in the issuer's records. Other elements may also be viewable, such as a stock frame image that is modified to reflect card specific information such as the CVC2 and/or an image or picture of the card account owner. The merchant can then request to view such card-back images, for example, to compare the user's signature on the receipt to that appearing on the mobile phone display screen (and/or to compare the image of the card account owner to the mobile phone user) to aid in authenticating the user's identity, and/or to view other information that may be included.

Referring again to FIG. 12, if in step 1210 the mobile phone user decides, after viewing the large image of the automatically-selected card account, that she does not wish to make a purchase, then (referring to FIG. 11) she can select 1216 the “Cancel” command icon 116 by actuating soft-key 120 (FIG. 1) and the process ends 1218. However, if in step 1210 the mobile phone user wishes to complete the payment transaction with another or different payment card account then she can then select the “Change” command icon 1114 by pressing the soft-key 118 (FIG. 1). In some embodiments, this causes the process to check 1220 if the payment card account is locked. If it is locked, then the mobile device displays 1222 a “Card Account Locked” message to the shopper (mobile phone user) and the process branches back to step 1208 wherein the large image of the card account is again displayed. At this point, the shopper has the option again to either cancel 1216 the transaction, or to proceed by entering 1212 her PIN.

However, if in step 1220 the card account is not locked, then the mobile telephone in configured to display 1224 the payment card images (FIG. 8) so that the shopper/mobile device user can make a different choice of payment card account. The process then proceeds to step 1226, wherein if a choice is made then that payment card account is displayed 1208 as a large image of the card account and the user proceeds as explained above to consummate the transaction. If, in step 1226 the user does not make a choice of another payment card account, then the process may idle as shown by branch 1228 for a predetermined amount of time after which the mobile telephone may, for example, exit to display the main menu screen. In addition, if in step 1206 there is no match for the merchant identifier (with any of the automatic card use criteria), then the process continues to step 1224 wherein the shopper is presented with payment card images and can select a payment card account to utilize in the transaction, as explained above.

The process illustrated in FIG. 12 has elements that promote transaction security both for the mobile telephone user (cardholder) and for the merchant. For the mobile telephone user, the requirement that she enter her PIN to enable the transaction adds a second (knowledge) factor to the first (possession) factor inherent in a payment-enabled mobile telephone. For the merchant, the display of the user's stored signature and/or photograph via the mobile telephone display allows the merchant to authenticate the user's identity with substantially the same reliability as has conventionally been applied with cardholder signatures and/or photographs appearing on the back of conventional payment cards (such as credit and/or debit cards).

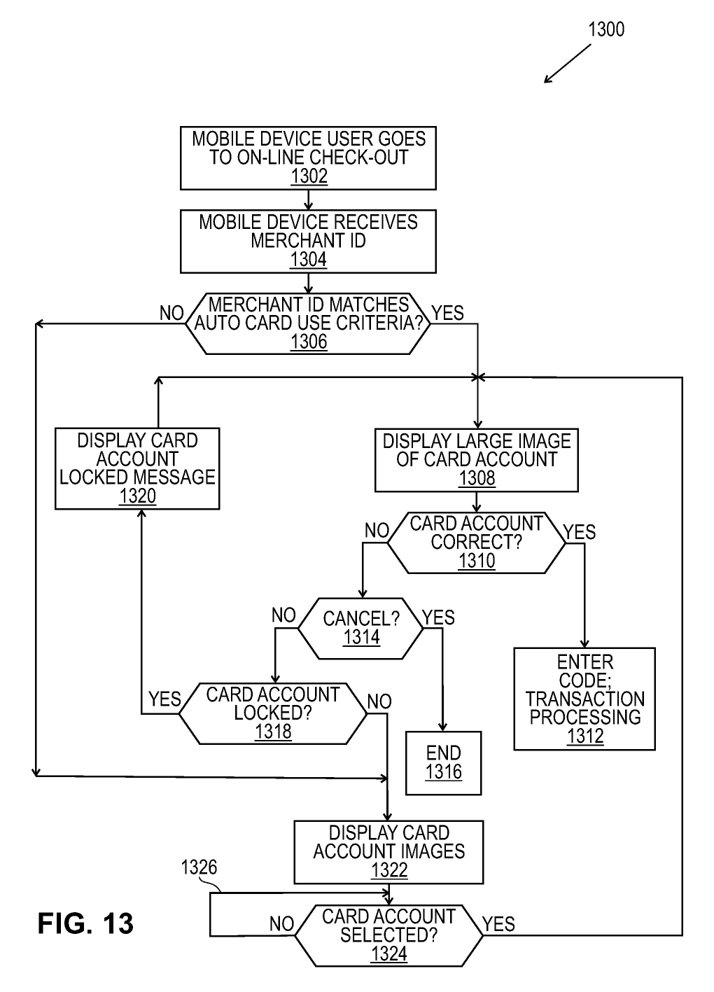

FIG. 13 is a flow chart illustrating yet another implementation of a process 1300 that a user may perform to purchase goods or services using the mobile phone/contactless payment device 100 in accordance with aspects described herein. The process 1300 is in the context of a mobile telephone user shopping on-line, for example on a website of an internet merchant, and is presented largely from the point of view of the user or consumer or shopper. The process assumes that the mobile telephone user has designated and/or configured at least one of her payment card accounts for automatic selection in accordance with the processes disclosed herein, so that when one or more of the predetermined user criteria or conditions is/are satisfied then a payment card account is automatically chosen for a purchase transaction.

Referring to FIG. 13, the shopper and mobile telephone user selects on-line items and goes 1302 to the virtual “check-out” provided by the merchant's website. In some embodiments, the mobile device then receives 1302 a payment request that includes a merchant identifier (merchant ID). If a match occurs in step 1306 between the merchant ID and criteria for a designated card account, then in some embodiments a large card account image (in the form of a payment card image) is displayed 1308 on the mobile telephone screen for viewing by the shopper. For example, the enlarged view 1100 shown in FIG. 11 of the display portion 104 of the mobile telephone 100 of FIG. 1 includes an embodiment of a large card-face image 1102 of the type that may be displayed. In some embodiments, an “Enter PIN” prompt 1118 may be displayed below the large card account image. In addition, a “Change” command icon 1114 may be included on the lower left portion of the screen, and a “Cancel” command icon 1116 can be included on the lower left portion of the screen, to allow the user to actuate a soft key to opt for selection of another payment card account number (Change) or another mobile telephone function (Cancel). As noted above, it should be understood that the mobile telephone may present the same or similar information to the user in other ways, such as by displaying simple strings of characters that indicate the automatically-selected payment card account number and branding information for that payment card account.

Referring again to FIG. 13, in some embodiments, the shopper acknowledges 1310 that the automatically selected card is correct by entering 1312 a code (such as her personal identification number (PIN) or a CVC code), for example by using the numeric keypad 112 of her mobile phone 100. The mobile phone may then operate, in some cases, to transmit the code to the website to consummate the transaction. In some embodiments, consummating the transaction may include the mobile phone wirelessly transmitting the selected payment card account number and code to the website. In accordance with some conventional practices, the mobile phone may cryptographically generate a dynamic security code (CVC3) for the transaction and transmit the dynamic security code to the on-line merchant's website.

Referring again to FIG. 12, if in step 1310 the mobile phone user decides, after viewing the large image of the automatically-selected card account, that she does not wish to make a purchase, then (referring to FIG. 11) she can select 1314 the “Cancel” command icon 116 by actuating soft-key 120 (FIG. 1) and the process ends 1316. However, if in step 1310 the mobile phone user wishes to complete the payment transaction with another or different payment card account then she can then select the “Change” command icon 1114 by pressing the soft-key 118 (FIG. 1). In some embodiments, this causes the process to check 1318 if the payment card account is locked. If it is locked, then the mobile device displays 1320 a “Card Account Locked” message to the shopper (mobile phone user) and the process branches back to step 1308 wherein the large image of the card account is again displayed. At this point, the shopper has the option again to either cancel 1314 the transaction, or to proceed by entering 1312 the code.

However, if in step 1318 the card account is not locked, then the mobile telephone is configured to display 1322 the payment card images (FIG. 8) so that the shopper/mobile device user can make a different choice of payment card account. The process then proceeds to step 1324, wherein if a choice is made then that payment card account is displayed 1308 as a large image of the card account and the user proceeds as explained above to consummate the transaction. If, in step 1324 the user does not make a choice of another payment card account, then the process may idle as shown by branch 1326 for a predetermined amount of time after which the mobile telephone may, for example, exit to display the main menu screen. In addition, if in step 1306 there is no match for the merchant identifier (with any of the automatic card use criteria), then the process continues to step 1322 wherein the shopper is presented with payment card images and can select a payment card account to utilize in the transaction, as explained above.

It will be observed that FIG. 11 and the other display screen figures are presented in the appended drawings quite a bit larger than life size. Thus the details, for example, of the enlarged card-face image 1102 of FIG. 11 are quite a bit more visible in the drawings than they may be in a practical embodiment of the present invention. In particular, the size of a mobile telephone display screen may only measure 2.5 inches diagonally, and even the larger touch-screen smart phone display screens are only 4.3 inches measured diagonally. Accordingly, to compensate for the small size of the card-face image that appears on these mobile telephone display screens, the virtual wallet application may include a “zoom” function that, for example, would allow the user to selectively enlarge portions of the image 1102. This may aid the user in reading information such as the payment card account number from the image 1102. The zoom function may be accessible by single-, double- or triple-clicking a soft-key or on portions of the image 1102 (if the mobile telephone is equipped with a touch screen). Alternatively, the zoom function may be accessible through an “Options” menu (not shown) that may be displayed in some of the menu or sub-menu embodiments for selection by the user actuating a soft key. For example, the main menu screen 600 of FIG. 6 includes an “Options” command icon in the lower left-hand corner that can be activated by the user actuating the soft-key 118 (see FIG. 1).

In some embodiments, the enlarged card-face images or the card-back images may be rotated relative to the display component so that the length axis of the image is aligned with the longer dimension of the display component.

In the examples described above, it has been assumed that the automatically-selected card account chosen by the card selection application installed in the mobile phone 100 is being used in connection with a payment or purchase transaction. However, it is contemplated that the automatically-selected card account can provide identification information (such as an identification number) that is not associated with a payment card account number, and the mobile phone may then be caused to interact with a proximity reader used for such operations as facilities access, transit system access, or some other purpose other than payment.

Embodiments of the invention, as described and depicted herein, may be particularly advantageous for providing a mobile device user with automatic card account selection functionality. In particular, the embodiments facilitate choosing and defining card accounts for use when various criteria and/or conditions are satisfied. In some embodiments, automatic-selection functions are accessible through the wallet icon on the main menu, so that the user may readily and conveniently set up that functionality. In some embodiments, various visual designs for the wallet icon and for other related automatic card account selection functions may be available for selection and/or downloading by the user, so that the user can customize the appearance of the main menu (at least to the extent of the wallet icon) and some sub-menus. At least some of the wallet icon visual designs and sub-menu icon designs may be produced by designers who are independent of the application provider and/or the issuers. In some embodiments, the mobile telephone user may be able to access a secure website from, for example, a desktop computer or a laptop computer, to select the criteria and/or conditions to associate with one or more of her card accounts, and have that data downloaded to the mobile phone device so that one or more card accounts can be automatically selected when the mobile phone is involved in a transaction. Such a secure website may provide the card account owner with a graphical user interface (GUI) for use in designating card accounts for automatic selection by the users' mobile device, wherein the GUI includes menus, sub-menus, text and icons similar to those presented and/or displayed by the mobile device for the same purpose. In some embodiments, the mobile device may include functionality that permits the automatic recognition of a location, such as a merchant retail store, to enable automatic selection of a payment card account for use in a transaction without requiring the user to tap his or her mobile device on a proximity device.

In some embodiments, the mobile phone may have voice recognition capabilities. Moreover, those capabilities may tie in to the automatic card selection application of the virtual wallet such that the user may be allowed to provide criteria for automatic card account selection in the wallet application simply by speaking the name of the card and the selected criteria for its' automatic use into the microphone of the mobile phone. For example, if the user speaks the words “Auto-Selection” and then “MasterCard debit” into the phone, in some embodiments this would cause the display screen to present automatic selection criteria that the user can choose to define when the user's MasterCard debit card will be automatically selected in future contactless purchase transactions in accordance with the processes described herein.

As the term “payment transaction” is used herein and in the appended claims, it should be understood to include the types of transactions commonly referred to as “purchase transactions” in connection with payment card systems.

As used herein and in the appended claims, the term “initiating a transaction” includes a proximity payment device such as a payment-enabled mobile telephone communicating a payment card account number to a POS terminal. The term “initiating a transaction” can also include a payment-enabled mobile device communicating with a website to transmit and receive data so as to enter into on-line payment transactions.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
providing, by a mobile device processor on a display component, a payment card account menu that includes a representation of each of a plurality of payment card accounts of a user stored in a memory of the mobile device;
receiving an indication of a selection by the user of a representation of a particular payment card account;
providing, by the mobile device processor in response to the indication, a card account use criteria sub-menu on the display component, the card account use criteria sub-menu including a plurality of criteria for selection by the user, the card account use criteria defining circumstances under which the particular payment card account will be automatically selected for a transaction;
receiving criteria data selected by the user; and
storing, by the mobile device processor in the memory, the selected criteria data in association with an identifier of the particular payment card account.

2. The method of claim 1, further comprising automatically selecting, by the mobile device processor, a particular payment card account for use in a payment transaction based at least in part on the stored criteria data.

3. The method of claim 2, further comprising transmitting the particular payment card account identifier to a merchant device as part of the payment transaction.

4. The method of claim 2, wherein automatically selecting a particular payment card account further comprises:
receiving, by the mobile device processor, transaction data from a merchant device; and
determining that at least a portion of the transaction data matches at least a portion of the selected criteria data of the particular payment card account.

5. The method of claim 4, wherein the transaction data comprises at least one of a merchant identifier, an item identifier, a transaction amount, a time of day, and a location.

6. The method of claim 4, wherein the transaction data is transmitted by at least one of a proximity device and an RFID tag associated with the merchant device.

7. The method of claim 1, wherein the mobile device is at least one of a mobile telephone, a music player, a personal digital assistant and a tablet computer.

8. The method of claim 1, wherein the representation of each of a plurality of payment card accounts of the user comprises a plurality of payment card images, wherein each payment card image represents a payment card account of the user.

9. The method of claim 1, wherein receiving criteria data comprises receiving data comprising a plurality of conditions for associating with the particular payment card account.

10. The method of claim 1, further comprising, prior to storing the selected criteria data:
displaying an enlarged card image on the display component corresponding to the particular payment card account and to the selected criteria data; and
receiving an indication from the user confirming the selections of the particular payment card account and the selected criteria data.

11. The method of claim 1, further comprising, prior to receiving an indication of a selection of a particular payment card account:
displaying a request on the display component for the user to enter at least one of a personal identification number (PIN) and a password;
receiving, by the mobile device processor, the at least one PIN and password;
validating the at least one PIN and password; and
permitting the user to select a particular payment card account.

12. The method of claim 1, further comprising locking the selected criteria data associated with the particular payment card account.

13. A computer readable medium storing non-transitory instructions for controlling a mobile device processor, the instructions configured to cause the processor to:
transmit instructions to display a payment card account menu on a display component that includes a representation of each of a plurality of payment card accounts of a user;
receive an indication of a selection by the user of a representation of a particular payment card account;
transmit instructions to display a card account use criteria sub-menu on the display component, the card account use criteria sub-menu including a plurality of criteria for selection by the user, the card account use criteria defining circumstances under which the particular payment card account will be automatically selected for a transaction;
receive criteria data selected by the user; and
store the selected criteria data in association with an identifier of the particular payment card account in a memory.

14. The computer readable medium of claim 13, further comprising instructions configured to cause the processor to automatically select a particular payment card account for use in a payment transaction based at least in part on the stored criteria data.

15. The computer readable medium of claim 14, further comprising instructions configured to cause the processor to transmit the particular payment card account identifier to a merchant device as part of the payment transaction.

16. The computer readable medium of claim 14, wherein the instructions for automatically selecting a particular payment card account further comprise instructions configured to cause the processor to:
receive transaction data from a merchant device; and
determine that at least a portion of the transaction data matches at least a portion of the selected criteria data of the particular payment card account.

17. The computer readable medium of claim 13, wherein the instructions for displaying a representation of each of a plurality of payment card accounts of a user further comprises instructions configured to cause the processor to transmit instructions to display a plurality of payment card images, wherein each payment card image represents a payment card account of the user.

18. The computer readable medium of claim 13, further comprising, prior to the instructions for storing the selected criteria data, instructions configured to cause the processor to:
display an enlarged card image on the display component corresponding to the particular payment card account and to the selected criteria data; and
receive an indication from the user confirming the selections of the particular payment card account and the selected criteria data.

19. The computer readable medium of claim 13, further comprising, prior to the instructions for receiving an indication of a selection of a particular payment card account, instructions configured to cause the processor to:
display a request on the display component for the user to enter at least one of a personal identification number (PIN) and a password;
receive the at least one PIN and password;
validate the at least one PIN and password; and
permit the user to select a particular payment card account.

20. The computer readable medium of claim 13, further comprising instructions for causing the processor to lock the selected criteria data associated with the particular payment card account.
